(19) United States
(12) Patent Application Publication
(10) Pub. No.: US 2026/0081997 A1
(43) Pub. Date: Mar. 19, 2026

(54) GENERATION OF USER-SPECIFIC TELEPHONY PROMPTS

(71) Applicant: Avaya Management L.P., Morristown, NJ (US)

(72) Inventors: Kevin Richard Plain, Dacono, CO (US); Ryan Robison, Leesburg, VA (US)

(21) Appl. No.: 18/887,129

(22) Filed: Sep. 17, 2024

(51) Int. Cl. H04M 3/523; H04M 3/51

(52) U.S. Cl. CPC H04M 3/523; H04M 3/5191; H04M 2203/408; H04M 2203/551

(57) ABSTRACT

Contact centers that handle real-time interactions with customers commonly utilize automated agents to handle one set of work items while human agents handle the work items that are more complicated, rare, or otherwise unable to be successfully resolved by an automated agent. Customers may erroneously select a human agent when an automated agent would suffice and, similarly, may be forced to wade through automated options when a human agent is required. Systems and methods disclosed herein provide for the determination of a reason, or a prioritized list of reasons, for a call and present resolution options to a specific customer for that specific reason(s). As a result, the resources of the contact center are better utilized and the customer experience improved.

### FIELD OF THE DISCLOSURE

The invention relates generally to systems and methods for optimizing contact center resources and particularly to curtailing the erroneous selection of resource-intensive agents.

### BACKGROUND

While many customers prefer to interact with humans over machines, this trend is declining. For many, including younger individuals who were born into the digital age, the demand for human agents is decreasing. Nonetheless, human agents will continue to have a place until artificial intelligence (AI) bots become intelligent enough to solve novel, rare, or complex customer problems. In the case of banking, as an example, people are increasingly using their bank's online portal as their primary destination for banking interactions. For many, this is already the case, and they only pick up a phone to call their bank when the online portal cannot solve their issue. These individuals are tech savvy and use phone calls only as a last resort. When they do use the phone, they often find themselves frustrated by a limited and confusing interactive voice response (IVR) system that only offers basic functions such as, “Press or say ‘1’ for your checking account balance; press or say ‘2’ for your last five transactions,” or, more generally, “In a few words, tell us what you are calling about.” Realistically, it's likely that in the near future, few will engage in phone calls, with most relying exclusively on portals or mobile applications.

### SUMMARY

Current IVR solutions are inflexible and often ineffective, circular, or poorly suited for advanced customers. They are tailored to the average user and not any specific user. Until such time that artificial intelligence (AI) can solve the majority of very complex issues, systems and methods need to more carefully route customers to automation, AI bots, and human agents.

These and other needs are addressed by the various embodiments and configurations of the present invention. The present invention can provide a number of advantages depending on the particular configuration. These and other advantages will be apparent from the disclosure of the invention(s) contained herein.

In one embodiment, callers to a contact center may be determined to be calling for an issue not readily resolved by an automated resource, such as a web interface to an online portal. Those that do need to reach a human agent are routed to a human agent faster without being unnecessarily presented with cumbersome, irrelevant options. Calls not requiring interaction with a human agent, may be more efficiently served by menu options that remove, de-emphasize, and/or de-prioritize options to connect to a human agent, and are more readily directed to automated resources, such as AI bots. As a result, customers are more likely to be served by automated agents, when the required service is available via an automated agent, in spite of the customer's preference to seek a live (i.e., human) agent. A call to an automated resource requires the allocation of networking resources (e.g., ports, switches, etc.) and computational resources (e.g., AI/automated agents, etc.), while using a human agent is more resource intensive. For example, a human agent engaged with one customer in a voice call is unable to process other tasks. In contrast, an automated agent may be able to process a great number of concurrent tasks. Additionally, the human agent, via an agent computer or other networked device, often interacts with the same system that would otherwise be used by an automated resource, except with the human agent as a “go between.” As a result, shepherding customers to automated agents, even when they believe a human agent is required, reduces the burden on networking and computational resources. Additionally or alternatively, determining that a customer does need a human agent, and reducing or eliminating irrelevant options used to shepherd customers to automated resources, reduces the time required to hold the connection and process responses that are irrelevant. Networking and processing resources of the system are improved by more quickly routing a customer, who actually needs a human agent, to a human agent, and removing or obfuscating options to select a human agent when an automated agent is sufficient.

In one embodiment, AI/machine learning is used to determine when to rearrange the IVR options. The resulting arrangement may be based on caller history and may put commonly used options first that are custom tailored to individual customer habits. For example, a customer may call in several times a week for their bank balance. As a result, the initial IVR may present their balance and, after that, offer more options. In another embodiment, the AI learns that some customers never call in unless they have a legitimate issue that only a human agent can resolve, which may be further determined by call analytics and/or voice analytics. In these cases, the IVR offers an agent as a first or more prominent option or even as a portion of an initial greeting, e.g., “Hello, Mr. Smith. Would you like to speak with an agent?” This change would be appreciated by customers who get frustrated with navigating circular IVR options and who ultimately prefer to speak with a human agent directly.

In another embodiment, the AI would also learn when a customer begins to abuse this level of direct access (using voice and call analytics) and discontinue offering them immediate access to human agents, thus optimizing the use of human agents. For example, if a customer frequently demands a human agent only to ask for a simple balance, the system would make the customer's IVR options for subsequent calls more difficult to reach a human agent and/or provide the account balances without any, or with reduced, customer prompting. The AI learning may also be given additional data beyond caller history and outcomes, such as from other systems providing at least some of the same services. For example, the others systems may comprise information from a customer's mobile application usage or online portal usage for the same (or commonly controlled) entity as the contact center. For example, the contact center's IVR system may be informed of the customer's time spent using the online portal or the application, the actions performed or attempted, number of particular operations, and/or temporal attributes of the operations. A machine learning system may then provide the IVR with instructions to route the customer directly to a human agent. Alternatively, when the IVR says, “In a few words, tell us why you are calling,” the AI would exclude simple tasks as potential solutions and favor more complex task resolutions.

In some aspects, the techniques described herein relate to a system, including: a network interface to a communication network; and a microprocessor coupled with a computer memory including computer readable instructions that, when read by the microprocessor, cause the microprocessor to perform: receiving a first call, via the network interface, from a customer device operated by a customer; after receiving the first call and before receiving any communication content within the first call, determining a set of potential reasons for the first call from a set of possible reasons; presenting a set of options, corresponding to the set of potential reasons for the first call, to the customer device; receiving a first selected option from the set of options; and routing the first call to a resource associated with the first selected option.

In some aspects, the techniques described herein relate to a system, further including: a connection to a server configured to perform a set of server operations corresponding to at least a portion of the set of potential reasons for the first call; and receiving, by the microprocessor, a data record from the server identifying a subset of the set of server operations performed by the customer; and wherein determining the set of potential reasons for the first call from the set of possible reasons further includes eliminating from the set of potential reasons, the portion of the set of possible reasons corresponding to the set of server operations performed by the customer.

In some aspects, the techniques described herein relate to a system, further including: a connection to a server, the server being configured to perform at least a portion of the set of potential reasons for the first call; and receiving, by the microprocessor, a data record from the server identifying successful connections to the server by the customer; and wherein determining the set of potential reasons for the first call from the set of possible reasons further includes eliminating from the set of potential reasons, the portion of the set of possible reasons corresponding to inaccessibility to the server.

In some aspects, the techniques described herein relate to a system, wherein: receiving the data record from the server further includes receiving the data record identifying a set of server operations performed by the customer; and determining the set of potential reasons for the first call from the set of possible reasons further includes eliminating from the set of potential reasons, the portion of the set of possible reasons corresponding to the set of server operations successfully performed.

In some aspects, the techniques described herein relate to a system, wherein: receiving the data record from the server further includes receiving the data record identifying a set of server operations performed multiple times by the customer; and determining the set of potential reasons for the first call from the set of possible reasons further includes selecting from the set of potential reasons, the portion of the set of possible reasons corresponding to the set of server operations performed a plurality of times by the customer.

In some aspects, the techniques described herein relate to a system, wherein: receiving the data record from the server further includes receiving the data record identifying a set of server operations unsuccessfully performed by the customer; and determining the set of potential reasons for the first call from the set of possible reasons further includes selecting from the set of potential reasons, the portion of the set of possible reasons corresponding to the set of server operations unsuccessfully performed.

In some aspects, the techniques described herein relate to a system, further including: determining the set of potential reasons for the first call from the set of possible reasons further includes selecting from the set of potential reasons, the portion of the set of possible reasons corresponding to access to the server.

In some aspects, the techniques described herein relate to a system, further including: a connection to a server, the server being configured to perform at least a portion of the set of potential reasons for the first call; and receiving, by the microprocessor, a data record from the server identifying unsuccessful connections to the server by the customer; and wherein determining the set of potential reasons for the first call from the set of possible reasons further includes eliminating from the set of potential reasons, the portion of the set of possible reasons corresponding to inaccessibility to the server.

In some aspects, the techniques described herein relate to a system, wherein the resource is an automated resource.

In some aspects, the techniques described herein relate to a system, wherein the resource includes a human resource.

In some aspects, the techniques described herein relate to a system, further including: upon determining the first selected option from the set of options was in error, setting a record associated with the customer indicating an attempt to game the system; receiving a second call, via the network interface, from the customer device operated by the customer; after receiving the second call and before receiving any communication content within the second call, determining the set of potential reasons for the first call from the set of possible reasons and excluding a portion of the set of potential reasons associated with the resource including the human resource; presenting the set of options, corresponding to the set of potential reasons for the second call, to the customer device; receiving a second selected option from the set of options; and routing the second call to the resource associated with the second selected option.

In some aspects, the techniques described herein relate to a system, wherein determining the set of potential reasons for the first call from the set of possible reasons further includes selecting from the set of potential reasons, a portion of the set of possible reasons corresponding an historic reason for a previous call having occurred at a common temporal attribute as the first call.

In some aspects, the techniques described herein relate to a method, including: receiving a first call, via a network interface, from a customer device operated by a customer; after receiving the first call and before receiving any communication content within the first call, determining a set of potential reasons for the first call from a set of possible reasons; presenting a set of options, corresponding to the set of potential reasons for the first call, to the customer device; receiving a first selected option from the set of options; and routing the first call to a resource associated with the first selected option.

In some aspects, the techniques described herein relate to a method, further including: connecting to a server configured to perform a set of server operations corresponding to at least a portion of the set of potential reasons for the first call; and receiving a data record from the server identifying a subset of the set of server operations performed by the customer; and wherein determining the set of potential reasons for the first call from the set of possible reasons further includes eliminating from the set of potential reasons, the portion of the set of possible reasons corresponding to the set of server operations performed by the customer.

In some aspects, the techniques described herein relate to a method, further including: connecting to a server, the server being configured to perform at least a portion of the set of potential reasons for the first call; and receiving a data record from the server identifying successful connections to the server by the customer; and wherein determining the set of potential reasons for the first call from the set of possible reasons further includes eliminating from the set of potential reasons, the portion of the set of possible reasons corresponding to inaccessibility to the server.

In some aspects, the techniques described herein relate to a method, wherein: receiving the data record from the server further includes receiving the data record identifying a set of server operations performed by the customer; and determining the set of potential reasons for the first call from the set of possible reasons further includes eliminating from the set of potential reasons, the portion of the set of possible reasons corresponding to the set of server operations successfully performed.

In some aspects, the techniques described herein relate to a method, wherein: receiving the data record from the server further includes receiving the data record identifying a set of server operations performed multiple times by the customer; and determining the set of potential reasons for the first call from the set of possible reasons further includes selecting from the set of potential reasons, the portion of the set of possible reasons corresponding to the set of server operations performed a plurality of times by the customer.

In some aspects, the techniques described herein relate to a method, wherein: receiving the data record from the server further includes receiving the data record identifying a set of server operations unsuccessfully performed by the customer; and determining the set of potential reasons for the first call from the set of possible reasons further includes selecting from the set of potential reasons, the portion of the set of possible reasons corresponding to the set of server operations unsuccessfully performed.

In some aspects, the techniques described herein relate to a method, further including: determining the set of potential reasons for the first call from the set of possible reasons further includes selecting from the set of potential reasons, the portion of the set of possible reasons corresponding to access to the server.

In some aspects, the techniques described herein relate to a computer-readable medium including one or more computer readable instructions that, when read by a microprocessor, cause the microprocessor to execute computer readable instructions to perform: receiving a first call, via a network interface, from a customer device operated by a customer; after receiving the first call and before receiving any communication content within the first call, determining a set of potential reasons for the first call from a set of possible reasons; presenting a set of options, corresponding to the set of potential reasons for the first call, to the customer device; receiving a first selected option from the set of options; and routing the first call to a resource associated with the first selected option.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,”“including,”and “having”can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a process in accordance with embodiments of the present disclosure;

FIG. 4 depicts an interaction in accordance with embodiments of the present disclosure;

FIG. 5 depicts an interaction in accordance with embodiments of the present disclosure;

FIG. 6 depicts an interaction in accordance with embodiments of the present disclosure; and

FIG. 7 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

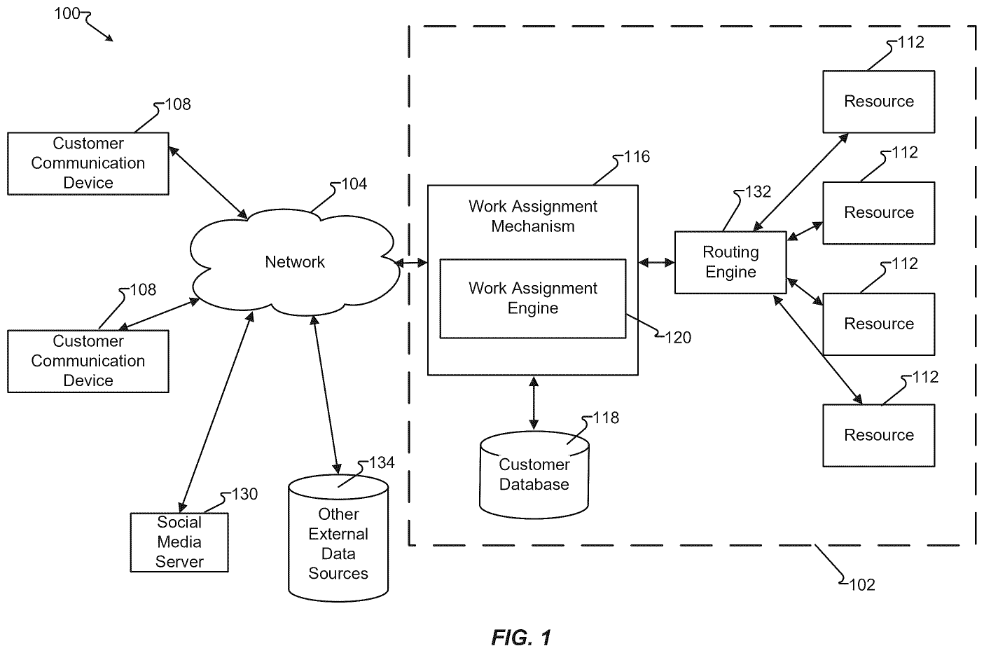

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., a company, an enterprise, etc.), and/or logical boundary (e.g., resources 112 utilized to provide services to customers of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Pat. No. 8,964,958 issued on Feb. 24, 2015 to Steiner, the entire contents of which are hereby incorporated herein by reference. Moreover, the communication network 104 may comprise a number of different communication media, such as a coaxial cable, copper cable/wire, fiber-optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., a collection of servers), a media request, an application request (e.g., a request for application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. Pat. No. 8,634,543 issued on Jan. 21, 2014, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed among a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

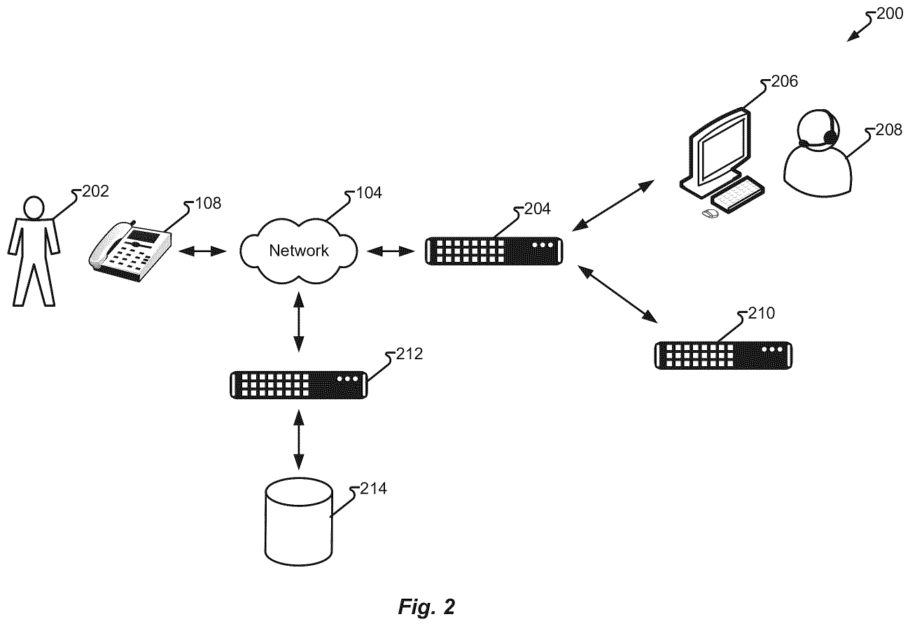

FIG. 2 depicts system 200 in accordance with embodiments of the present disclosure. System 200 illustrates one topology of components. One of ordinary skill in the art will appreciate that other topologies and/or specific components may be utilized without departing from the scope of the embodiments.

In one embodiment, customer 202 uses customer communication device 108 (e.g., a telephone) to contact a resources 112 to initiate a work item; the work item being the reason for the call. The call, conveyed via network 104, is initially received (e.g., answered) by server 204 providing interactive voice response (IVR) functions, dual-tone multi-frequence (DTMF) based selections, and/or natural language processing. The purpose of server 204 is to assess the reason for the call and route the call to the appropriate resource 112. One resource 112 is human agent 208 utilizing agent device 206 to receive and process calls. Another resource 112 is automated resource 210 that, via generated/recorded speech, interacts with customer 202 to perform the work item and thereby successfully complete the work item.

Generally, automated resource 210 is a less resource-intensive option to resolve a work item. Certain customers, such as customer 202 may prefer automated resource 210 over human agent 208. However, automated resource 210 may not be able to handle all work items. For example, if customer 202 is calling to report an unauthorized transaction, human agent 208 may be required to gather details of the transaction and any relevant information related to the transaction. Presenting and processing options for automated resources, such as server 204, when human agent 208 is required, similarly burdens the computing and networking resources of system 200. Therefore, when customer 202, after initially being connected to server 204, states or selects, “agent,” the likelihood they are calling for a routine reason (e.g., within the capabilities of automated resource 210) is low. Accordingly, server 204 may present a prioritized set of options weighted towards routing the call to human agent 208 or a human agent having a particular set of skills associated with the work item.

In another embodiment, customer 202 may have had prior interactions with server 212, such as a server providing web-based services. Customer 202 may have accessed an online account and performed, or attempted to perform, a particular action. Database 214 may preserve an indicum of the actions, such as the action performed, action taken that performed no transaction (e.g., viewing a statement), etc., and/or a timestamp and/or count of occurrences. As an example, if customer 202 accessed an account balance from web server (e.g., server 212) within the last five minutes and is now calling to connect to a resource 112 of contact center 102, then server 204 may determine that customer 202 knows their account balance and is calling for a different issue. Accordingly, server 212 does not present “account balance” at all or in an initial set of options used to route the call to a resource 112. As a further option, server 204 may route the call based on a set of likely issues that may occur after customer 202 has viewed a statement presented by web server 212. For example, the reason may be to inquire about a particular transaction or to report an error. Accordingly, server 204 may present options corresponding to such determined reasons and route the call accordingly.

As a further option, customer 202 may call at known periods of time and perform the same action. For example, customer 202 may call their bank on the first and fifteenth of the month to get their account balance. Accordingly, server 204, upon receiving a call from customer 202, may access a database (e.g., database 214 or another database (not shown)) and see if such a temporal pattern exists. If, for example, it is the 15^{th} of the month, server 204 may determine the reason for the call is to inquire about the account balance and, in response, present an “account balance” option to customer 202 without prompting or with reduced prompting over other options. Conversely, if the call is on the 21^{st} of the month, the “account balance” option may be removed or de-prioritized and placed deeper in the queue of options (e.g., a set of options that include “something else,” which is then selected by customer 202 and, in response, “account balance”is presented as an option).

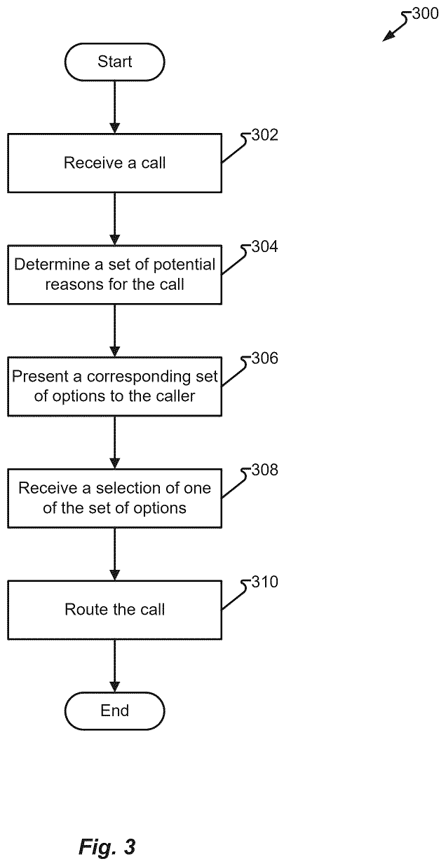

FIG. 3 depicts process 300 in accordance with embodiments of the present disclosure. In one embodiment, process 300 is embodied as machine-readable instructions maintained in a non-transitory memory that when read by a machine, such as a processor of a server, cause the machine to execute the instructions and thereby execute process 300. The processor of the server may include, but is not limited to, at least one processor of server 212, 204, and/or 210.

Process 300 begins and, in step 302, a call is received. The call comprises content, such as speech provided by customer 202 and/or an agent (human and/or automated). The call may comprise selection content (e.g., spoken selection, dial pad selection, etc.) that is provided to a first resource 112, such as an IVR agent, that presents options for selection by customer 202. The first resource 112 is unable to resolve the work item without input from, or transferring the call to, another resource 112. For example, a request for an account balance may be provided by transferring the call to an automated resource 112 or, such as via an application programming interface (API), query another automated resource 112 for the account balance and provide the response to the query to customer 202. However, the first resource 112 is configured primarily, if not exclusively, to determine a reason for the call and identify an associated resource (e.g., another resource 112) that can resolve the reason. The call is then transferred to the associated resource.

In step 304 a set of reasons is determined for the call. The determination of the potential reasons is variously embodied. In one embodiment, a superset of all potential services and their associated reasons available is identified and, from that list, non-applicable reasons are eliminated. For example, process 300 may be embodied as a banking process. The hosting bank may offer a number of services, which are initially identified. When a customer calls (e.g., customer 202) they are authenticated and identified. If, for example, the customer already has a checking account then the reasons for the call that are associated with opening of a checking account (e.g., open a regular checking account, open a money market account with check writing privileges, etc.) may be eliminated.

In another embodiment, the potential reasons are determined from an initial list with no or few options and with reasons added as they become identified as potential reasons for the call. For example, customer 202 may call a bank and, having a car loan with the bank, have reasons for the call associated with the car loan added to the list of reasons.

In another embodiment, the potential reasons for the call may be based on interactions with another resource, such as server 212. Customer 202 may have recently performed an interaction on server 212 (e.g., booked a flight, obtained an account balance, etc.) and, therefore, step 304 may eliminate the recently performed interactions as the reason for the call and, in step 306, selectable options associated with the recently performed interactions from the list of options presented to the customer. Additionally or alternatively, interactions with server 212 may indicate transactions (performed or attempted) and associated reasons. For example, customer 202 booked a flight with server 212 and now (e.g., five minutes later) is calling. Accordingly, the reason may be to correct a mistake (e.g., change flight) or request a related service (e.g., special meal, wheelchair service, an upgrade, etc.). Accordingly, step 306 then generates/selects and presents options related to the mistaken bookings and/or related services for newly booked flights.

Step 308 receives a selection of one of the set of options from customer 202 and, in step 310, routes the call in accordance with the selection.

Returning to step 304, in another embodiment, the determination of the set of potential reasons for the call may be determined by providing a data set to an AI. The data set may comprise one or more of an attribute of customer 202 (e.g., demographic, location, etc.), attribute of one or more prior interactions between customer 202 and contact center 102 (e.g., call history), one or more prior interactions of customer 202 with an automated resource (e.g., web portal, application, etc.), and/or attributes of prior interactions with customer 202 with the automated resource (e.g., operations performed, operations failed, frequency of one or more operations, temporal attribute of one or more operations, etc.). The AI may comprise a neural network provided with a first set of training data, such as via accessing a prior data set (e.g., a data set of customer 202 and/or a data set(s) of one or more different customers). The prior data set may include one or more transformations to the prior data set, such as selecting an automated agent, selecting a human agent, altering a work item to require an automated agent, altering a work item to require a human agent, altering a work item to not require a human agent, altering a work item to require to not require an automated agent, or altering an explicitly stated level of urgency to create a modified set of data. Training the neural network, in a first training stage, on the first set of training data. Generating a second set of training data comprising the first set of training data and results for the first training stage that incorrectly determined a human agent was required to resolve the work item when an automated agent would suffice, that incorrectly determined that an automated agent was required to resolve the work item when a human agent was required, and/or incorrectly determined the reason for the call. Training the neural network in a second training stage with the second set of training data. Once trained, the neural network is provided with the data set from a customer (e.g., customer 202) and a result received therefrom, determining a set of reasons for the call.

The reason, in some embodiments, may be a prioritized list corresponding to the most likely reasons for the call. In another embodiment, the reasons for the call may be prioritized and the corresponding prioritized set of options (such as may be provided by step 306) determined based on a need for a human agent versus an automated agent or vice versa (e.g., options 1-3 are associated with an automated agent, and options 4-6 are associated with a human agent). In another embodiment, the option presented may be associated with a single reason (e.g., “Would you like your account balance?” “Would you like to speak with an agent?” etc.). As a further option, step 308 may be omitted, the response assumed (e.g., “Your account balance is . . . ”, “I will now connect with a (human) agent,”etc.), and the call routed in step 310 accordingly.

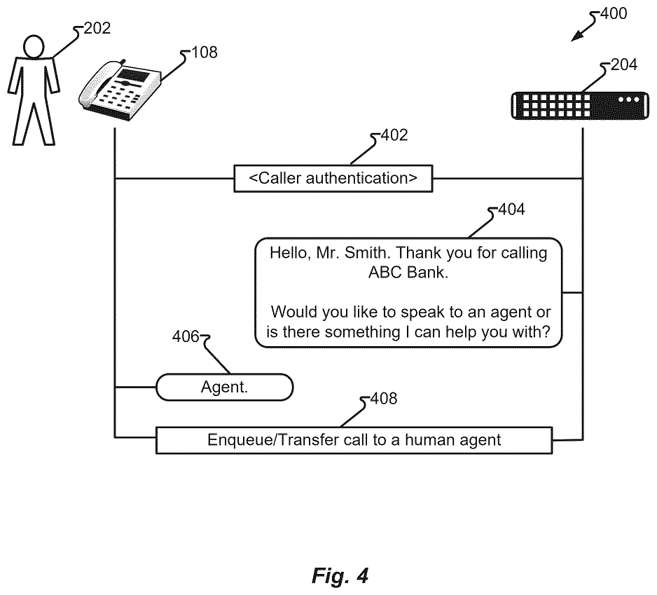

FIG. 4 depicts interaction 400 in accordance with embodiments of the present disclosure. In one embodiment, customer 202, utilizing customer communication device 108, is engaged in a communication with server 204. Step 402 authenticates customer 202, such as via Caller ID, password, pin, voiceprint, etc. Authentication step 402 may be performed by server 204 and/or another component of contact center 102. One authentication is complete, an interaction between customer 202 and server 204 begins.

In one embodiment, dialog 404 may initially greet customer 202 and present a single option (e.g., “Would you like to speak to a (human) agent?”) based on a determined reason for the call (see FIG. 3, step 306). Notably absent is the presentation of options that are not determined (in the embodiment illustrated in dialog 404) to be the reason for the call (e.g., obtain an account balance, etc.) as, in one embodiment, the set of reasons for the call excludes reasons associated with automated agents, such as obtaining account balances. Customer 202 selects an option (e.g., speaking the word, “agent”) in dialog 406 and, in response, the call is enqueued or transferred to a human agent in step 408.

In another embodiment, customer 202 may respond with, “something else” in dialog 406, and a prioritized list of options may be presented by server 204 for selection. Additionally or alternatively, the result may be provided back to the determination process, such as an AI, to indicate the error and down-weight or correct such determinations of the reason in subsequent calls. Conversely, when customer 202 accepts the suggested option(s), feedback may be provided to an AI to reinforce the determination of the reason for the call.

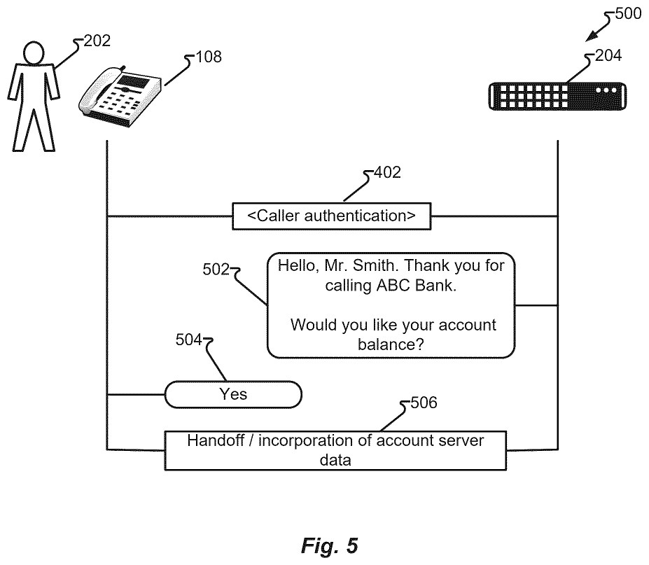

FIG. 5 depicts interaction 500 in accordance with embodiments of the present disclosure. In one embodiment, customer 202, utilizing customer communication device 108, is engaged in a communication with server 204. Step 402 authenticates customer 202, such as via Caller ID, password, pin, voiceprint, etc. Authentication step 402 may be performed by server 204 and/or other component of contact center 102. One authentication is complete, an interaction between customer 202 and server 204 begins.

In one embodiment, server 204 presents dialog 502 which greets customer 202 and presents an option in response to a determined reason for the call (see FIG. 3, step 306). The single option (in the embodiment illustrated) is associated with an automated agent. In another embodiment, dialog 502 may determine the reason, either absolutely or with a certainty above a previously determined threshold, and automatically obtain and provide a response (e.g., “Hello, Mr. Smith. Thank you for calling ABC Bank. Your checking account balance, ending in 1234, is $7,573.11. Is there anything else I can help you with today?”). Dialog 504 comprises the response from customer 202 and, as a result, the call is handed off to an automated agent or server 204, in step 506, that connects with an appropriate repository to respond with the answer (not shown).

In another embodiment, had customer 202 responded with, “something else” or “no” in dialog 504, a prioritized list of options may be presented by server 204 for selection. Additionally or alternatively, the result may be provided back to the determination process, such as an AI, to indicate the error and down-weight or correct such determinations of the reason in subsequent calls. Conversely, when customer 202 accepts the suggested option(s), feedback may be provided to an AI to reinforce the determination of the reason for the call.

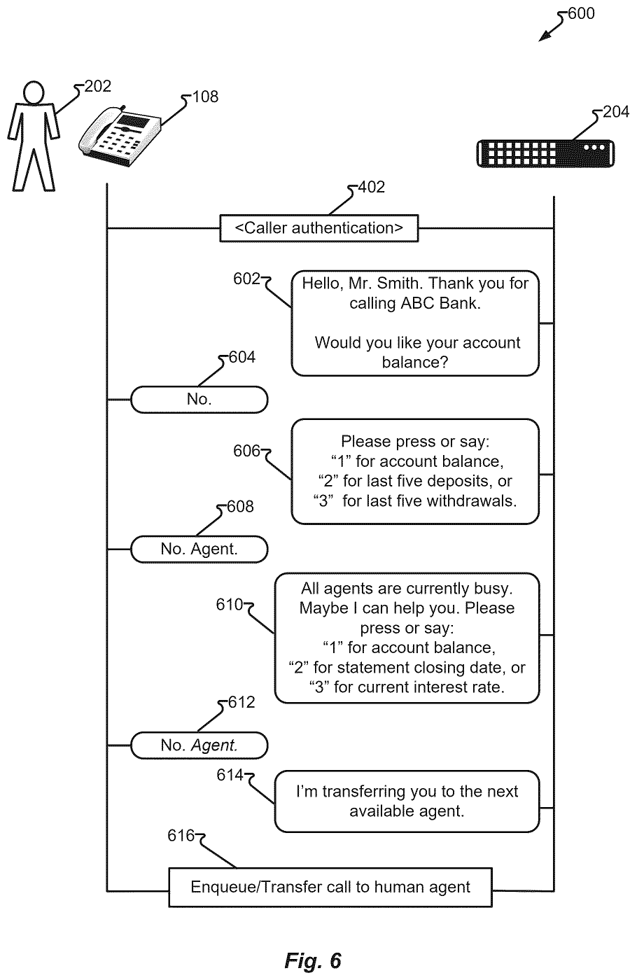

FIG. 6 depicts interaction 600 in accordance with embodiments of the present disclosure. In one embodiment, customer 202, utilizing customer communication device 108, is engaged in a communication with server 204. Step 402 authenticates customer 202, such as via Caller ID, password, pin, voiceprint, etc. Authentication step 402 may be performed by server 204 and/or other component of contact center 102. One authentication is complete, an interaction between customer 202 and server 204 begins.

In one embodiment, server 204 presents dialog 602 which greets customer 202 and presents an option associated with a determined reason for the call. For example, customer 202 may frequently (e.g., more than a threshold number) and/or at temporal intervals (e.g., 1^{st} and 15^{th} of the month) call contact center 102, such as to request information. The information being a work item associated with an automated agent (e.g., obtain an account balance).

Customer refuses the suggested option in dialog 604 and, in response, server 204 presents dialog 606 associated with a prioritized list of options corresponding to a prioritized list of reasons determined for the call. Dialog 606 may be, or include, the same option as presented in dialog 602. For example, customer 202 may be determined to call and be insistent on a human agent when an automated agent can readily resolve the work item (e.g., provide the account balance). As a result, server 204 may more aggressively prompt the customer 202 to interact with an automated agent and/or more aggressively dissuade customer 202 from interacting with a human agent.

Customer 202 may provide dialog 608 that again refuses a suggested option (each being associated with a corresponding determined reason for the call) and/or selecting a different option (e.g., “Agent”). Server may accommodate the request and connect customer 202 to a human agent or provide dialog 610 re-presenting existing options, presenting new options, or a combination thereof. Customer 202 may accept one of the options or provide dialog 612 refusing the options and/or selecting a different option (e.g., “Agent”). In response server 204 may accommodate the request in step 614 and enqueue/transfer the call to a human agent in step 616.

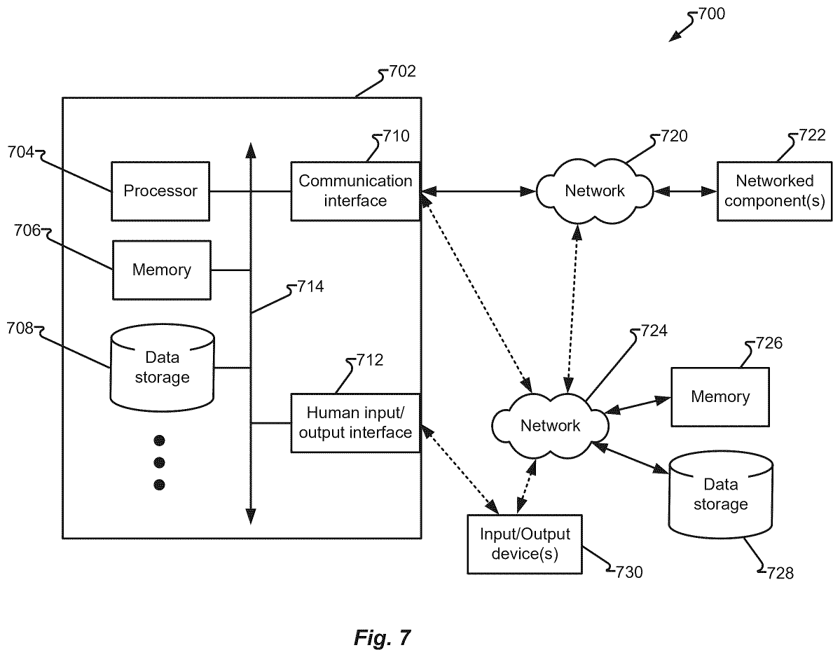

FIG. 7 depicts device 702 in system 700 in accordance with embodiments of the present disclosure. In one embodiment, server 212, server 204, and/or server 204 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may comprise programmable logic functionality, such as determined, at least in part, from accessing machine-readable instructions maintained in a non-transitory data storage, which may be embodied as circuitry, on-chip read-only memory, computer memory 706, data storage 708, etc., that cause the processor 704 to perform the steps of the instructions. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize computer memory 706 and/or data storage 708 for the storage of accessible data, such as instructions, values, etc. Communication interface 710 facilitates communication with components, such as processor 704 via bus 714 with components not accessible via bus 714 and may be embodied as a network interface (e.g., ethernet card, wireless networking components, USB port, etc.). Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or configured to utilize one or more networks, such as network 720 and/or network 724.

Network 104 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.).

Additionally or alternatively, one or more other networks may be utilized. For example, network 724 may represent a second network, which may facilitate communication with components utilized by device 702. For example, network 724 may be an internal network to a business entity or other organization, such as contact center 102, whereby components are trusted (or at least more so) than networked components 722, which may be connected to network 720 comprising a public network (e.g., Internet) that may not be as trusted.

Components attached to network 724 may include computer memory 726, data storage 728, input/output device(s) 730, and/or other components that may be accessible to processor 704. For example, computer memory 726 and/or data storage 728 may supplement or supplant computer memory 706 and/or data storage 708 entirely or for a particular task or purpose. As another example, computer memory 726 and/or data storage 728 may be an external data repository (e.g., server farm, array, “cloud,” etc.) and enable device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of computer memory 706, data storage 708, computer memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, a switch, a port, or other communication component such that a particular output of processor 704 enables (or disables) input/output device 730, which may be associated with network 720 and/or network 724, to allow (or disallow) communications between two or more nodes on network 720 and/or network 724. For example, a connection between one particular customer, using a particular customer communication device 108, may be enabled (or disabled) with a particular networked component 722 and/or particular resource 112. Similarly, one particular networked component 722 and/or resource 112 may be enabled (or disabled) from communicating with a particular other networked component 722 and/or resource 112, including, in certain embodiments, device 702 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a communication network; and
a microprocessor coupled with a computer memory comprising computer readable instructions that, when read by the microprocessor, cause the microprocessor to perform:
receiving a first call, via the network interface, from a customer device operated by a customer;
after receiving the first call and before receiving any communication content within the first call, determining a set of potential reasons for the first call from a set of possible reasons;
presenting a set of options, corresponding to the set of potential reasons for the first call, to the customer device;
receiving a first selected option from the set of options; and
routing the first call to a resource associated with the first selected option.

2. The system of claim 1, further comprising:
a connection to a server configured to perform a set of server operations corresponding to at least a portion of the set of potential reasons for the first call; and
receiving, by the microprocessor, a data record from the server identifying a subset of the set of server operations performed by the customer; and
wherein determining the set of potential reasons for the first call from the set of possible reasons further comprises eliminating from the set of potential reasons the portion of the set of possible reasons corresponding to the set of server operations performed by the customer.

3. The system of claim 1, further comprising:
a connection to a server, the server being configured to perform at least a portion of the set of potential reasons for the first call; and
receiving, by the microprocessor, a data record from the server identifying successful connections to the server by the customer; and
wherein determining the set of potential reasons for the first call from the set of possible reasons further comprises eliminating from the set of potential reasons the portion of the set of possible reasons corresponding to inaccessibility to the server.

4. The system of claim 3, wherein:
receiving the data record from the server further comprises receiving the data record identifying a set of server operations performed by the customer; and
determining the set of potential reasons for the first call from the set of possible reasons further comprises eliminating from the set of potential reasons the portion of the set of possible reasons corresponding to the set of server operations successfully performed.

5. The system of claim 3, wherein:
receiving the data record from the server further comprises receiving the data record identifying a set of server operations performed multiple times by the customer; and
determining the set of potential reasons for the first call from the set of possible reasons further comprises selecting from the set of potential reasons the portion of the set of possible reasons corresponding to the set of server operations performed a plurality of times by the customer.

6. The system of claim 3, wherein:
receiving the data record from the server further comprises receiving the data record identifying a set of server operations unsuccessfully performed by the customer; and
determining the set of potential reasons for the first call from the set of possible reasons further comprises selecting from the set of potential reasons the portion of the set of possible reasons corresponding to the set of server operations unsuccessfully performed.

7. The system of claim 3, further comprising:
determining the set of potential reasons for the first call from the set of possible reasons further comprises selecting from the set of potential reasons the portion of the set of possible reasons corresponding to access to the server.

8. The system of claim 1, further comprising:
a connection to a server, the server being configured to perform at least a portion of the set of potential reasons for the first call; and
receiving, by the microprocessor, a data record from the server identifying unsuccessful connections to the server by the customer; and
wherein determining the set of potential reasons for the first call from the set of possible reasons further comprises eliminating from the set of potential reasons, the portion of the set of possible reasons corresponding to inaccessibility to the server.

9. The system of claim 1, wherein the resource is an automated resource.

10. The system of claim 1, wherein the resource comprises a human resource.

11. The system of claim 10, further comprising:
upon determining the first selected option from the set of options was in error, setting a record associated with the customer indicating an attempt to game the system;
receiving a second call, via the network interface, from the customer device operated by the customer;
after receiving the second call and before receiving any communication content within the second call, determining the set of potential reasons for the first call from the set of possible reasons and excluding a portion of the set of potential reasons associated with the resource comprising the human resource;
presenting the set of options, corresponding to the set of potential reasons for the second call, to the customer device;
receiving a second selected option from the set of options; and
routing the second call to the resource associated with the second selected option.

12. The system of claim 1, wherein determining the set of potential reasons for the first call from the set of possible reasons further comprises selecting from the set of potential reasons a portion of the set of possible reasons corresponding to a historic reason for a previous call having occurred at a common temporal attribute as the first call.

13. A method, comprising:
receiving a first call, via a network interface, from a customer device operated by a customer;
after receiving the first call and before receiving any communication content within the first call, determining a set of potential reasons for the first call from a set of possible reasons;
presenting a set of options, corresponding to the set of potential reasons for the first call, to the customer device;
receiving a first selected option from the set of options; and
routing the first call to a resource associated with the first selected option.

14. The method of claim 13, further comprising:
connecting to a server configured to perform a set of server operations corresponding to at least a portion of the set of potential reasons for the first call; and
receiving a data record from the server identifying a subset of the set of server operations performed by the customer; and
wherein determining the set of potential reasons for the first call from the set of possible reasons further comprises eliminating from the set of potential reasons the portion of the set of possible reasons corresponding to the set of server operations performed by the customer.

15. The method of claim 13, further comprising:
connecting to a server, the server being configured to perform at least a portion of the set of potential reasons for the first call; and
receiving a data record from the server identifying successful connections to the server by the customer; and
wherein determining the set of potential reasons for the first call from the set of possible reasons further comprises eliminating from the set of potential reasons the portion of the set of possible reasons corresponding to inaccessibility to the server.

16. The method of claim 15, wherein:
receiving the data record from the server further comprises receiving the data record identifying a set of server operations performed by the customer; and
determining the set of potential reasons for the first call from the set of possible reasons further comprises eliminating from the set of potential reasons the portion of the set of possible reasons corresponding to the set of server operations successfully performed.

17. The method of claim 15, wherein:
receiving the data record from the server further comprises receiving the data record identifying a set of server operations performed multiple times by the customer; and
determining the set of potential reasons for the first call from the set of possible reasons further comprises selecting from the set of potential reasons the portion of the set of possible reasons corresponding to the set of server operations performed a plurality of times by the customer.

18. The method of claim 15, wherein:
receiving the data record from the server further comprises receiving the data record identifying a set of server operations unsuccessfully performed by the customer; and
determining the set of potential reasons for the first call from the set of possible reasons further comprises selecting from the set of potential reasons the portion of the set of possible reasons corresponding to the set of server operations unsuccessfully performed.

19. The method of claim 15, further comprising:
determining the set of potential reasons for the first call from the set of possible reasons further comprises selecting from the set of potential reasons the portion of the set of possible reasons corresponding to access to the server.

20. A computer-readable medium comprising one or more computer readable instructions that, when read by a microprocessor, cause the microprocessor to execute computer readable instructions to perform:
receiving a first call, via a network interface, from a customer device operated by a customer;
after receiving the first call and before receiving any communication content within the first call, determining a set of potential reasons for the first call from a set of possible reasons;
presenting a set of options, corresponding to the set of potential reasons for the first call, to the customer device;
receiving a first selected option from the set of options; and
routing the first call to a resource associated with the first selected option.
